(19) United States
(12) Patent Application Publication
(10) Pub. No.: US 2016/0094607 A1
(43) Pub. Date: Mar. 31, 2016

(54) METHOD AND APPARATUS FOR REAL-TIME PROTOCOL HEADER GENERATION

(71) Applicant: MOTOROLA SOLUTIONS, INC., Schaumburg, IL (US)

(72) Inventors: TYRONE D. BEKIARES, Park Ridge, IL (US); BARUH HASON, TEL AVIV-YAFFO (IL); GABI OFIR, RESHON LETZION (IL); VALENTIN OPRESCU-SURCOBE, Northbrook, IL (US)

(21) Appl. No.: 14/502,302

(22) Filed: Sep. 30, 2014

(51) Int. Cl. H04L 29/06; H04W 4/10

(52) U.S. Cl. CPC H04L 65/607; H04W 4/10; H04L 65/608; H04L 65/403

(57) ABSTRACT

A media server and method of operation of a media server in a wireless communication system are provided. The media server receives media streams from mobile communication devices in the wireless communication system, and routes the media streams sequentially to a packet header compression encoder. A processor of the media server is configured to receive a first media stream from a first mobile communication device, receive a request from a second mobile communication device to transmit a second media stream to the media server, and transmit data derived from an RTP header of the first media stream to the second mobile communication device. The second mobile communication device is enabled to commence transmission of the second transmitted media stream using the data derived from the RTP header. The wireless communication system may be a PTT wireless communication system or a group video wireless communication system.

### BACKGROUND OF THE INVENTION

Real-time Transport Protocol (RTP) is a protocol used to transport streaming video and audio media across IP networks. Further details are provided by specification RFC3550.

An RTP packet comprises: a header, comprised of at least an identification of source(s) that provided the packet, a timestamp indicating the capture time of the first byte of payload data, and a sequence number indicating the order of the packet in a sequence of packets; and the payload data that the RTP packet is transporting. Packets formatted in accordance with the RFC3550 specification include at least 12 bytes of header information. However, RTP header compression may be used to reduce the size of this RTP header appreciably. The reduction is achieved by eliminating duplicative data and/or encoding fields using delta encoding.

In LTE systems, an RTP header compression encoder may be contained within the LTE infrastructure. Such an RTP header compression encoder may typically operate in accordance with standard RObust Header Compression (ROHC) behaviour. Further details are provided by the RFC3095 specification.

An ROHC encoder has three states: Initialization and Refresh (IR), First Order (FO), and Second Order (SO). FIG. 1 depicts a table showing these three states, and describes characteristics of them. An ROHC encoder always starts out in the IR state at the onset of an RTP stream, and then moves (relatively) slowly to FO and SO states. This progression occurs as the ROHC encoder gains confidence in the decoder's state.

ROHC was devised with long duration, single source to single destination streams in mind, such as one-to-one audio or video telephony. Here ‘long duration’ may mean streams of several minutes or more in duration. In such situations, ROHC may offer considerable savings, and has been considered an effective compression technique.

The design assumptions on which ROHC was based do not always apply to the communications that occur in Push-to-Talk (PTT) communications. A typical PTT talkburst lasts only seconds, rather than minutes. Moreover, a PTT server receives streams from multiple sources (“inbound” streams), and multiplexes them, serially, into a single “outbound” stream. The single outbound stream targets a given talkgroup. Also, outbound PTT streams target many users, rather than a single destination, and typically utilize a multicast or broadcast transmission mechanism. All of these facets of PTT represent challenges to the assumptions that underlie ROHC.

Similarly, the design assumptions on which ROHC was based do not always apply to communications that occur in a group video wireless communication system. A group video wireless communication system may be configured similar to a PTT system, whereby a video server receives audio and/or video streams from multiple sources (“inbound” streams), and multiplexes them, serially, into a single “outbound” audio and/or video stream.

In a wireless PTT communication system, the ROHC encoder starts in the IR state when any member of a talkgroup begins a talkburst transmission, because that transmission is a new and unique stream of video and/or audio media. If that transmission were to last, for example, many seconds or perhaps a minute, then the ROHC encoder would be likely to transition to the FO state. If the transmission were to last for a sufficient duration, the ROHC encoder would then be likely to transition further to the SO state. Hence useful compression would be achieved. However, many transmissions in a wireless PTT communication system will be too short for a transition even to the FO state to occur, and no compression is achieved. Other, slightly longer transmissions, may allow a transition to the FO or even the SO state, but for only the duration of the current transmission. The next source to transmit on the talkgroup will reset the ROHC to the IR state. As such, only a minimal amount of compression can be achieved, even under optimal circumstances. Similarly, in a group video wireless communication system, only a minimal amount of compression can be achieved, even under optimal circumstances

In a PTT-over-wireless-IP (Internet Protocol) architecture, it is advantageous to use RTP header compression to reduce the overall bit rate of PTT streams. However, using known RTP header compression, each new transmission from a participant in the PTT talkgroup will appear to the ROHC encoder as a new and unique stream. As such, each new PTT talkburst would have to undergo the series of ROHC state transitions foreseen in the RTP standard, i.e., IR to FO to SO.

Multicast/broadcast services for LTE (i.e., eMBMS) are optimized for streams with non-varying packet sizes and bit rates. eMBMS bearers must typically be sized to accommodate the largest packet size and bit rate that a stream will produce. In this case, the eMBMS bearer would need to be sized to accommodate the larger headers transmitted in the IR and FO states. When the stream transitions to SO encoding, the unused resources may be wasted, thus nullifying the benefits of employing ROHC.

Accordingly, there is a need for a method and apparatus for real-time protocol header generation.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a table showing features of the three Robust Header Compression states.

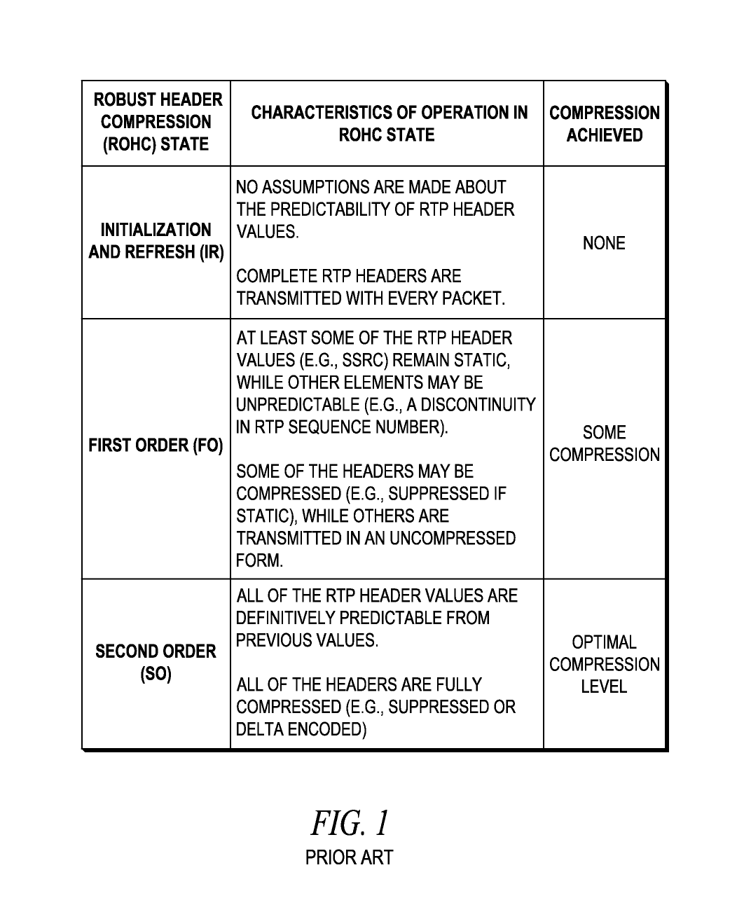

FIG. 2 is a method of operation of a media server in a wireless communication system in accordance with some embodiments.

FIG. 3 is a schematic of a wireless communication system in accordance with the some embodiments.

FIG. 4 is a flowchart of a method in a media server in accordance with some embodiments.

FIG. 5 is a flowchart of a method in a communication device in accordance with some embodiments.

FIG. 6 is a communication device in accordance with some embodiments.

FIG. 7A is a message sequence chart for communications originating from a first communication device.

FIG. 7B is a message sequence chart for communications originating from a second communication device, after the communications originating from the first communication device in FIG. 7A.

FIG. 8 is a table illustrating the calculation of each variable held in the table of the media server.

FIG. 9 is a media server in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

A media server in a wireless communication system is operable to receive media streams from mobile communication devices in the wireless communication system and to route the media streams sequentially to a packet header compression encoder. A processor of the media server is configured to receive a first media stream from a first mobile communication device, and to receive a request from a second mobile communication device to transmit a second media stream to the media server. The processor of the media server is configured to transmit data derived from an RTP header of the first media stream to the second mobile communication device, whereby the second mobile communication device is enabled to commence transmission of the second media stream using the data derived from the RTP header.

The wireless communication system may be a wireless Push-To-Talk (PTT) communication system. Alternatively, the wireless communication system may be a group video wireless communication system. Where the following illustrative examples discuss talkbursts in a wireless Push-To-Talk (PTT) communication system, the steps and features apply equally to transmissions in a group video wireless communication system.

The media server is operable to receive media streams that target talkgroups comprising mobile communication devices in the wireless communication system. The media server is further operable to route the media streams sequentially through the packet header compression encoder (ROHC encoder) for onward repeat transmission to other devices configured to receive media streams on the designated talkgroup.

The packet header compression encoder may be an RTP header compression encoder. When a first data packet of the second media stream uses the data derived from the RTP header, the RTP header compression encoder will process the first data packet of the second media stream as if it were a next successive data packet of the first media stream, which has now finished. When the RTP header compression encoder had encoded the header of the final data packet of the first media stream in the FO state or the SO state, the RTP header compression encoder will encode the header of the first data packet of the second media stream in that state. In particular, the RTP header compression encoder will not return to an IR state, for the encoding of the header of the first data packet of the second media stream.

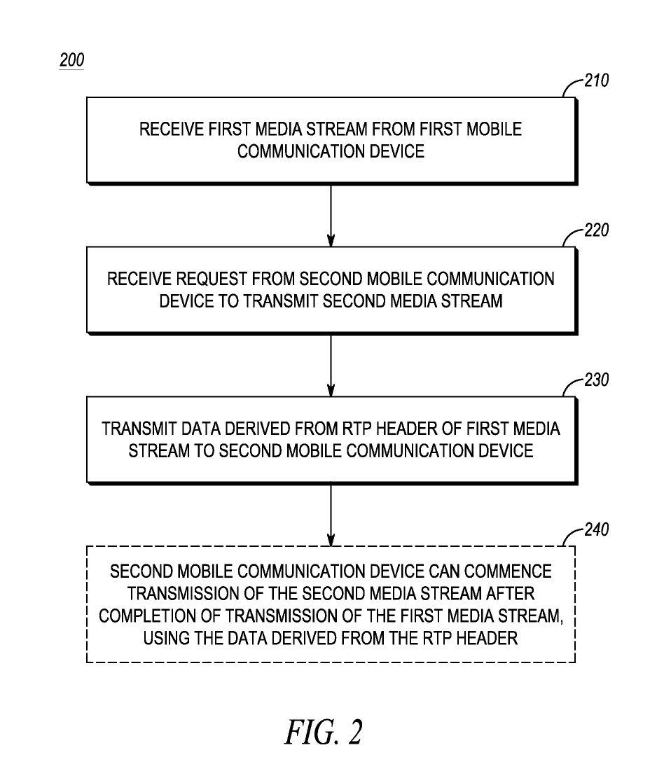

FIG. 2 is a flowchart of a method of operation 200 of the media server.

In step 210, the media server receives the first media stream from the first mobile communication device. In step 220, the media server receives a request from the second mobile communication device to transmit the second media stream. In step 230, the media server transmits data derived from an RTP header of first media stream to the second mobile communication device.

In step 240, the second mobile communication device can commence transmission of the second media stream after completion of transmission of the first media stream, using the data derived from the RTP header. Step 240 is shown in dotted form, because it is not a step carried out by the media server itself.

The first and second media streams comprise packets of data. The RTP header may be the header of the last packet of data of the first media stream that is received by the media server.

The media server may be configured to transmit data derived from the RTP header comprising a source identifier unique to a given talkgroup, which may be a synchronization source identification number (i.e., SSRC), a next sequential packet number, derived from a previous sequential packet number of the last packet of data of the first media stream, and a next time stamp value, derived from a previous time stamp value of the last packet of data of the first media stream.

The media server may be configured to route the first and second media streams sequentially to an RTP header compressor for onward ‘repeat’ transmission to mobile communication devices of the talkgroup of which the first and second communication devices are part. The RTP header compressor will encode a first packet of the second media stream in a compression state that had been used for the last packet of the first media stream. The RTP header compressor may be a ROHC encoder, for example in an LTE system.

Considering the method of FIG. 2 in more detail, when the first mobile communication device relinquishes the floor, the second mobile communication device requests the floor. However, in contrast to known systems, the first packet of the second transmitted media stream, e.g., a talkburst from the second mobile communication device, will sequentially appear as the successor to the last packet of the first transmitted media stream from the first mobile communication device. Thus the cycle of ROHC state transitions foreseen in the RTP standard, i.e., IR to FO to SO, does not need to re-start with the first packet of the talkburst from the second mobile communication device. Significant savings in header size may be achieved by this method, therefore, in wireless communication systems.

A PTT system may operate in accordance with several constraints. Before considering further a system that may implement the method of RTP header compression, four of these constraints are considered. The table below lists the four constraints

TABLE 1
Constraints on media server operation

1. The server is required to provide a media repeat service. For example,
various communication devices of a talkgroup, plus a dispatcher, will
address talkburst RTP packets to the server. The server then has to
repeat the talkbursts to affiliated communication devices of the talkgroup,
over multi-unicast or multicast bearers.
2. The server has to provide a floor control service, to request
and grant a communication device of the talkgroup exclusive
rights to transmit a talkburst on the talkgroup.
3. The server cannot modify the SSRC, RTP Sequence Number,
and RTP Timestamp when repeating media, because this would
break the end-to-end header integrity protection and/or encryption
(e.g., as provided by SRTP).
4. The ROHC encoder is a non-modifiable entity within the network,
for example within a wireless LTE transmission network.
The ROHC encoder is automatically engaged when RTP streams
are identified. The method of RTP header compression
may operate despite these constraints.

Further considering the operation of a media server under these constraints, the media server will receive a source of a stream of RTP packets from a communication device of a talkgroup that is transmitting a media stream, e.g., a talkburst. The packets are identified by a 32-bit numeric SSRC identifier carried in the RTP header, so as not to be dependent upon the network address. All packets from a synchronization source form part of the same timing and sequence number space, so a receiver groups packets by synchronization source for playback. Examples of synchronization sources include the sender of a stream of packets derived from a signal source such as a microphone or a camera, or an RTP mixer.

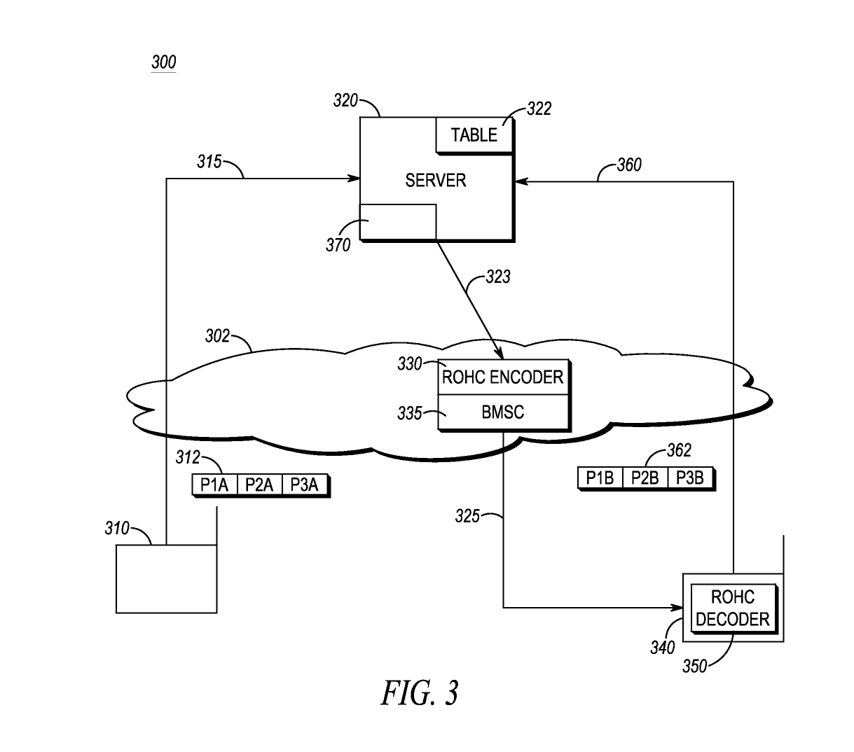

Returning now to the method illustrated by the flowchart of FIG. 2, FIG. 3 provides a schematic of a wireless communication system 300 in accordance with some embodiments. The explanation of FIG. 3 will be made using the example of wireless communication system 300 being a wireless PTT communication system, and the transmissions being talkbursts. However, the discussion of FIG. 3 applies equally to video transmissions in a group video wireless communication system.

Various communication devices of PTT system 300 are linked to each other via a media server 320. Media server 320 comprises processor 370. PTT system 300 is arranged with all PTT media streams, e.g., talkbursts, flowing from an originating communication device to server 320 first. At server 320, the media streams are repeated in either a multi-unicast or multicast fashion, to talkgroup participants. Those participants may be mobile communication devices, and may also include fixed devices and/or a dispatcher.

When repeated by media server 320, the source IP address and port will be reassigned to that of media server 320. Thus all RTP packets transmitted on a given talkgroup will have the same source and destination addressing information. Further, media server 320 will enforce floor control, such that only one talkburst is transmitted on a given talkgroup at a given time. The server protocol may be built on standard OMA (Open Mobile Alliance) PTT-over-Cellular (PoC) behaviour, though any PTT-over-IP system can be used. Per standard OMA PoC behaviour, when a potential source wishes to transmit on a talkgroup, it sends a Talk Burst Control Protocol (TBCP) REQUEST to media server 320. Media server 320, in turn, grants the request via a TBCP GRANT message.

In PTT system 300, media server 320 multiplexes talkbursts from various disparate communication devices of a PTT talkgroup into the same ROHC session. Sometime after the start of this process, the header compression applied to the talkbursts will be in the SO state. The remainder of the communications on this talkgroup may then continue in this SO state without incurring a non-optimal ROHC transition back to the FO or IR state, despite changes of the communication device that is providing a talkburst, i.e., despite various different communication devices taking over the floor. Thus PTT system 300 implements a method of RTP header compression, but without the frequent reversions to the FO or IR state that occur in known systems when a new communication device starts transmitting.

For example, suppose a first communication device 310 transmits 315 a first media stream 312 to media server 320. Three packets of first media stream 312 are shown in FIG. 3, which include P1A, P2A and P3A. Transmission 315 is via LTE (Long-Term Evolution) network 302.

Media server 320 maintains a table 322 of values for the SSRC, nextSequenceNumber, lastTimestamp, and nextTimestamp for each configured talkgroup. This 4-tuple is referred to as TG[SSRC, NSEQ, LTS, NTS]. In the case of FIG. 3, both first communication device 310 and a second communication device 340 are part of the same talkgroup. The media server 320 may be an OMA PoC server. The grant message provided by the media server 320 may then be a TBCP GRANT message. Media server 320 may support multiple talkgroups. Two or more talkgroups may be active simultaneously.

A talkgroup will be first initialized on the server either after a reboot, or after being provisioned. When first communication device 310 requests the floor, media server 320 provides a TBCP GRANT message to first communication device 310.

In contrast to standard media server behaviour, the floor grant, which may be a TBCP GRANT, is augmented to include the TG[SSRC, NSEQ, NTS] state. When the talkgroup is initialized on media server 320, TG[SSRC, NSEQ, NTS] may be initialized to random values using a random number generator. Alternatively, some or all of TG[SSRC, NSEQ, NTS] may be initialized to a predetermined number. TG[LTS] is initialized to TG[NTS]. The TBCP protocol is notably built on the RTCP protocol, which allows for arbitrary header extensions to be augmented to existing messages. Further, the added headers may be integrity protected, along with the rest of the TBCP headers, using standard Secure RTCP (SRTCP) mechanisms.

In response to receipt of the TBCP GRANT message, first communication device 310 seeds its own SSRC, RTP Sequence Number, and RTP Timestamp state with the values specified in the TBCP GRANT message. Finally, the RTP RFC standard indicates that a SSRC should be unique amongst sources in an RTP session. This requirement exists to distinguish concurrent sources from one another. PTT system 300, however, can enforce floor control, and thus does not allow multiple sources to transmit simultaneously. If multiple sources cannot transmit simultaneously, this negates a need for SSRC uniqueness amongst sources transmitting on the same talkgroup.

In an alternate embodiment, the first floor grant does not include some or all of the TG[SSRC, NSEQ, NTS] values. In this case, the first communication device initializes the missing values, i.e., the first communication device initializes some or all of its local SSRC, RTP Sequence Number, and RTP Timestamp states from a random number generator, or may set them to a predetermined number.

After first communication device 310 receives the TBCP GRANT, at the start of the first media stream 312, first communication device 310 transmits 315 a first RTP packet P1A to media server 320. The header of the first RTP packet P1A starts with the appropriate initialized SSRC, RTP Sequence Number, and the RTP Timestamp. For the duration of the first media stream 312 from first communication device 310, the SSRC value will remain constant. The RTP Sequence Number and RTP Timestamp values will increase across packets as dictated by the rules of the RTP Profile.

Whilst first communication device 310 is transmitting RTP packets as part of the first media stream 312, media server 320 ‘repeats’ the transmitted packets to the unicast and multicast addresses of communication devices that wish to receive the call. The packets are transmitted 323 to the LTE network 302. As media server 320 repeats the packets, media server 320 changes the source IP and source port to those of the source IP and source port of media server 320. Further, as media server 320 is repeating the RTP packets, it is continually updating the TG[NSEQ, LTS, NTS] state for the talkgroup. TG[NSEQ, LTS, NTS] is maintained in table 322 of media server 320.

TG[SEQ] represents the next expected RTP Sequence Number. This value is calculated as follows: the next RTP Sequence Number is generated by adding a value of 1 to the received RTP Sequence Number, modulo 2̂16 (to accommodate a wrap at 16 bits).

TG[NTS] is calculated by subtracting TG[LTS] from the received RTP Timestamp, and adding the result to the received RTP Timestamp, modulo 2̂32 (to accommodate a wrap at 32 bits). TG[LTS] is then set to the value of the received RTP Timestamp.

Notably, for SRTP (Secure RTP) streams, SSRC, RTP Sequence Number, and RTP Timestamp are not encrypted, but rather integrity protected. Optionally, media server 320 may hold the decryption key for the talkgroup. Media server 320 can then perform integrity validation on the received SSRC, RTP Sequence Number, and RTP timestamps before updating the TG [NSEQ, LTS, NTS] state.

Media streams reflected by media server 320 are encoded by ROHC encoder 330, which is located in LTE network 302. The media streams are then transmitted 325 to devices such as second communication device 340.

The first reflected stream processed by ROHC encoder 330 comprises packets from the first media transmission 312 that originated at first communication device 310. ROHC encoder 330 processes these packets for transmission 325 to talkgroup recipients. In FIG. 3, second communication device 340 is shown as a talkgroup recipient, using ROHC decoder 350 to receive packets that ROHC encoder 330 has transmitted 325.

As packets of this first reflected stream are processed, ROHC encoder 330 may transition from the IR to FO to SO states as per standard operating procedure, if the transmission lasts long enough. Alternatively, ROHC encoder 330 can be arranged to directly enter the SO state with synchronization headers transmitted in an out-of-band channel, as described in co-pending application U.S. patent application Ser. No. 14/320,224. When ROHC encoder 330 is arranged to directly enter the SO state, this permits any new affiliates to the talkgroup to join at any arbitrary point in time, e.g., in-between talkbursts or mid-talkburst.

Sometime after the first communication device 310 relinquishes the floor, another source requests the floor via a TBCP REQUEST. Assume that the requesting device is second communication device 340. Media server 320 responds to the TBCP REQUEST from second communication device 340 with a second TBCP GRANT. However, the second TBCP GRANT is augmented to include the current TG[SSRC, NSEQ, NTS] state for the talkgroup, from table 322. Notably, TG[NSEQ] and TG[NTS] have been calculated as described above.

Second communication device 340 is thereby enabled to transmit 360 a second media stream 362, which is illustrated as comprising three packets P1B, P2B and P3B. The first packet P1B of the second media stream 362 will sequentially appear as the successor to the last packet of the first media stream 312. This occurs because the second communication device has used the values from the TG[SSRC, NSEQ, NTS] state as ‘Seed’ values, to create the first packet P1B of the second media stream 362.

Thus, when second communication device 340 requests the floor, media server 320 will provide a TBCP GRANT to second communication device 340 with TG[SSRC, NSEQ, NTS] values that enables second communication device 340 to seed its own SSRC, RTP Sequence Number, and RTP Timestamp state, as appropriate. Then the second media stream 362 is transmitted 360 to media server 320. Media server 320 may reflect packets of the second media stream 362 to various devices, including ROHC encoder 330 in LTE network 302.

As part of that reflection, media server 320 again changes the source IP address and port of the packets to those of media server 320. As before, media server 320 tracks and calculates TG[NSEQ, LTS, NTS] for each packet reflected, and updates table 322 accordingly.

Notably, the TBCP protocol does not suggest inclusion of SSRC, next RTP Sequence Number, and next RTP Timestamp values as part of a floor grant. The RTP protocol does not suggest that an originator of a media stream, for example the first 310 or second 340 communication devices, seed their SSRC, RTP Sequence Number, or RTP Timestamp from any external source such as media server 320.

The above methods and systems may provide enhancements over known systems functioning in accordance with the standards, by allowing talkbursts transmitted on a single talkgroup to share the same ROHC context, thus avoiding state transitions at the start of each talkburst. In known systems, the IP 5-tuple (source IP address, destination IP address, source port, destination port, and protocol) uniquely identifies an IP source. The IP 5-tuple therefore uniquely identifies an RTP stream. As such, without changes to the system architecture, intuitively each of the various unique talkbursts on a talkgroup in a known system would appear to the ROHC as a new RTP stream, and thus would each be subject to the IR→FO→SO transition. A media server repeating a source packet to the talkgroup in a known system could, theoretically, have overwritten the SSRC, RTP sequence Number, and RTP Timestamp headers of each repeated packet to ensure the output values remain predictable across talkspurts. Such behavior, however, would have broken the Secure RTP (SRTP) integrity protection, as the SSRC, RTP Sequence Number, and RTP Timestamp headers are protected by a message integrity hash.

Further, if this IP 5-tuple were to simply remain static across talkbursts, the ROHC state would still reset to FO or IR when the SSRC header changes, or when the RTP Sequence Number or the RTP Timestamp values exhibit a non-predictable discontinuity. All of these header values are generated by the source of the talkburst. The RTP RFC suggests that these values may be initialized to random values, which will ensure discontinuity in values between talkbursts, and thus ensure a non-optimal ROHC transition. Hence the solutions that were enabled and anticipated by the standards could not prevent the re-start of the IR→FO→SO transition for each new talkburst.

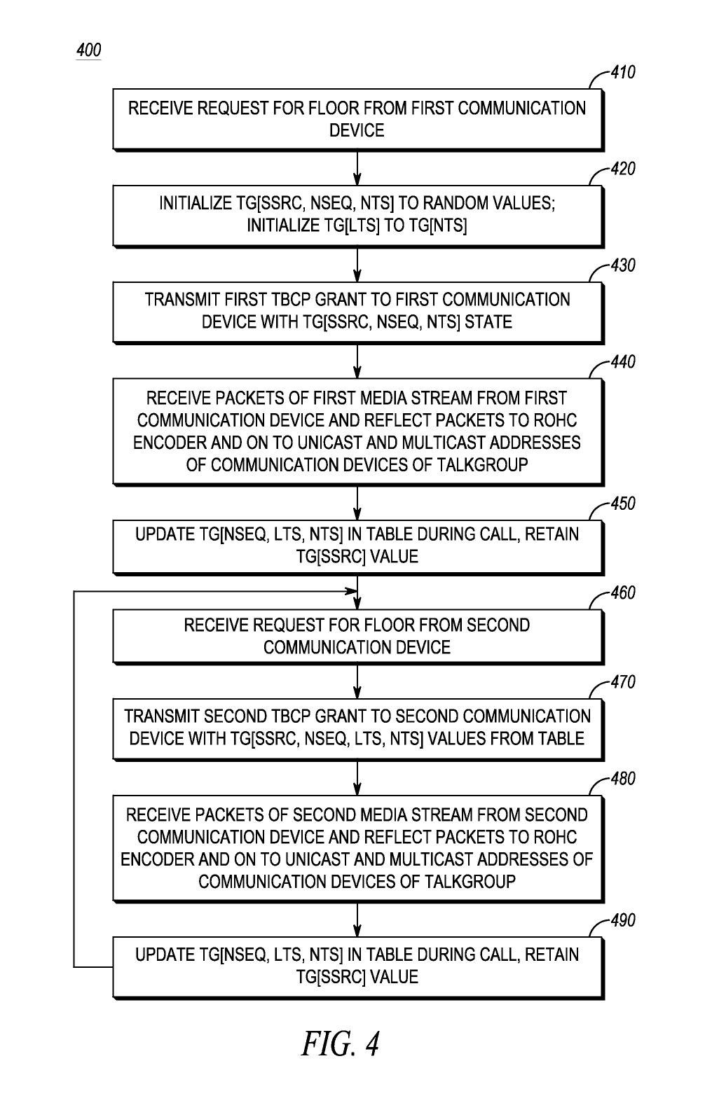

FIG. 4 is a flowchart of a method 400 in a media server in accordance with some embodiments. The steps of FIG. 4 are described in connection with media server 320 of FIG. 3

In step 410, media server 320 receives a request for the floor from first communication device 310. In step 420, media server 320 initializes the TG[SSRC, NSEQ, NTS] and the corresponding values in its table 322 to random values, and initializes TG[LTS] to TG[NTS].

In step 430, media server 320 responds to the request from first communication device 310 by transmitting a first TBCP GRANT to first communication device 310. The first TBCP GRANT comprises the initial TG[SSRC, NSEQ, NTS] state for use by the first communication device 310.

First communication device 310 can then transmit first media stream 312 to media server 320. At step 440, media server 320 receives packets of first media stream 312 from first communication device 310 and reflects the packets to the unicast and multicast addresses of communication devices in the talkgroup.

In step 450, media server 320 updates TG[NSEQ, LTS, NTS] in the table 322 during the call, and retains the TG[SSRC] value. At some point during transmission 325 of the first media stream 312, ROHC encoder 330 may undergo one of the state transitions foreseen in the RTP standard, i.e., IR to FO, or even to SO.

At step 460, media server 320 receives a request for the floor from second communication device 340. At step 470, media server 320 transmits a second TBCP GRANT, to second communication device 340. The second TBCP GRANT comprises the current TG[SSRC, NSEQ, LTS, NTS] values from table 322 of media server 320. The current TG[NSEQ] and TG[NTS] values have been updated from the initial TG[SSRC, NSEQ, NTS] state used in step 430.

At step 480, analogously to step 440, media server 320 receives packets of the second media stream 362 from second communication device 340. Media server 320 reflects the packets to the unicast and multicast addresses of communication devices of the talkgroup, see again transmission 323 in FIG. 3.

In step 490, analogously to step 450, media server 320 updates TG[NSEQ, LTS, NTS] in table 322 during the transmission 360 of the second media stream 362 of the call/connection, and continues to retain the TG[SSRC] value. After step 490, the method 400 is shown returning to the point immediately ahead of step 460.

The method may continue around the loop of steps 460-490. The method would pass through these steps for each communication device that transmits a talkburst during the call. However, in each successive pass through steps 460-490, the communication device to which the TBCP grant is transmitted will change, but may once again at some point become the first communication device 310 or second communication device 340 again.

The method and system described will, in many operating scenarios, avoid the situation with known systems whereby the ROHC state will be reset to IR, with a slow progression to FO and SO at the start of each talkburst. A PTT system implementing the invention reduces over-the-air bit rate compared to known systems. eMBMS resources would be appreciably reduced in many operating scenarios. Analogous enhancements would be achieved in a group video wireless communication system. The mobile communication devices in a group video wireless communication system would send audio and/or video media streams analogously to the first media stream 312 and second media stream 362 in FIG. 3. Analogous steps to those in FIG. 4 would be used to process the video and speech media streams. Likewise, the steps in FIG. 4 apply to communication systems that employ other RTP header compressors than the illustrative example of the ROHC encoder 330 in FIG. 3.

Notably, the mechanism disclosed is compatible with third party mobile communication devices, e.g., user equipments (UEs). The TG[SSRC, NSEQ, NTS] state may be included as standards compliant header extensions to the TBCP GRANT. Therefore, third party UEs can safely ignore these extensions. Alternatively, assuming that TBCP GRANTs are unicast to the requesting source, media server 320 may be adapted to choose to remove such fields from the TBCP GRANTs when addressing a third party communication device. In either case, third party communication devices, such as UEs, transmitting to a talkgroup will cause a discontinuity in the SSRC, RTP Sequence Number, and/or RTP Timestamp. Such a discontinuity causes a non-optimal ROHC transition at the start of any talkbursts they originate. However, although non-optimal, such ROHC transitions are allowable. Regardless of whether the source is a communication device operating in accordance with the method of the invention, or alternatively a third party UE, the repeated ROHC stream is 100% standards compliant, and compatible with both communication devices operating in accordance with the invention, and third party UEs. So media server 320 can operate either with all UEs of a talkgroup that are adapted to implement the methods described, or with a talkgroup comprising some UEs that are adapted to implement the methods and some third party UEs that are not.

The mechanisms described in U.S. patent application Ser. No. 14/320,224 allow communication devices that operate in accordance with the invention to enter a talkgroup, or a talkburst, late. Support for third party UE late entrants is not easily accomplished via the ROHC RFC standard. However, this would be possible if the teachings of application Ser. No. 14/320,224 were standardized. It would also be possible to limit the method and system described herein only for talkgroups that are known to contain only communication devices that operate in accordance with the invention.

Notably, the mechanism disclosed is applicable both for multicast and multi-unicast distribution of media streams/talkbursts. The mechanism is also applicable for both unencrypted and SRTP end-to-end encrypted streams.

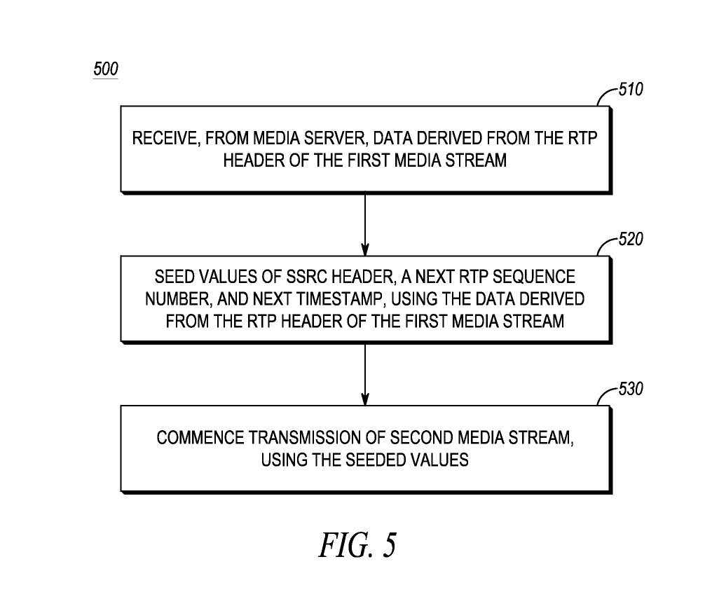

FIG. 5 is a flowchart of a method 500 in a communication device in accordance with some embodiments. The steps of FIG. 5 are described in connection with second communication device 340 of FIG. 3, which originates second media stream 362 in FIG. 3.

In step 510, the ROHC decoder 350 of second communication device 340 receives, from ROHC encoder 330, data derived from the RTP header of the first media stream 312. ROHC encoder 330 is operating as an RTP header compressor.

In step 520, second communication device 340 seeds values of the SSRC header, a next RTP sequence number, and a next timestamp NTS. To do this, second communication device 340 uses the data derived from the RTP header of the first media stream 312, which it has received in a GRANT message.

In step 530, second communication device 340 commences transmission 360 of the second transmitted media stream 362, using the seeded values to construct the header of the first packet P1B of the second transmitted media stream 362.

The media server 320 or the first communication device 310 may be configured to initialize each of the sequential packet number and the last time stamp value to either a random number or a predetermined number, when a talkgroup comprising the first communication device 310 is initialized. In this case, when the media server 320 is responding to a request from the first mobile communication device 310 to transmit the first media stream and the first mobile communication device has initialized both the sequential packet number and the last time stamp value, the media server 320 is configured to transmit the source identifier to the first communication device 310.

The media server 320 or the first communication device 310 may be configured to initialize the source identifier to a random number, when a talkgroup comprising the first communication device 310 is initialized. In this case, when responding to a request from the first mobile communication device to transmit the first media stream and the media server 320 has initialized the source identifier to a random number, the media server 320 is configured to transmit the source identifier to the first communication device 310.

The media server 320 or the first communication device 310 may be configured to initialize the source identifier to a predetermined number, when a talkgroup comprising the first communication device 310 is initialized. In this case, when responding to a request from the first mobile communication device to transmit the first media stream and the media server 320 has initialized the source identifier to a predetermined number, the media server 320 is configured to transmit the source identifier to the first communication device 310.

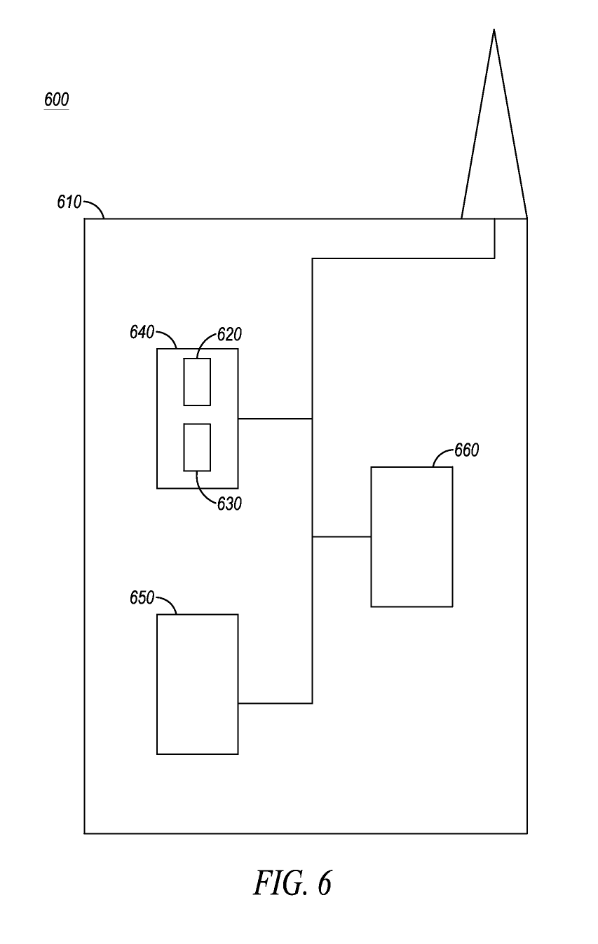

FIG. 6 is a block diagram of a wireless communication device 600 in accordance with some embodiments. Wireless communication device 600 may correspond to either of first communication device 310 or second communication device 340. Other wireless communication devices in the talkgroup may have the configuration and functionality described below for wireless communication device 600.

Wireless communication device 600 comprises a housing 610. Within housing 610 are a transmitter 620 and receiver 630. Transmitter 620 and receiver 630 form part of a transceiver 640. Wireless communication device 600 also comprises at least one memory device 650, which stores program code for implementing the methods described. Memory device 650 is coupled to a processor 660. Memory device 650 may comprise, but is not limited to, a hard disk, a CD-ROM, an optical storage device, a magnetic storage device, random access memory (RAM), dynamic random access memory (DRAM), a ROM (Read Only Memory), a PROM (Programmable Read Only Memory), an EPROM (Erasable Programmable Read Only Memory), an EEPROM (Electrically Erasable Programmable Read Only Memory) a Flash memory, or equivalents. Memory device 650 maintains data and programs that may be executed by the associated processor 660 and that allow wireless communication device 600 to perform all functions necessary to operate in communication system 300. Processor 660 of wireless communication device 600 may comprise one or more microprocessors, microcontrollers, digital signal processors (DSPs), customized processors, field programmable gate arrays (FPGAs), or combinations thereof or such other devices known to those having ordinary skill in the art. Processor 660 may be configured to execute the functions described herein as being executed by any of the mobile communication devices in communication system 300.

Wireless communication device 600 may be a mobile communication device in a wireless Push-To-Talk (PTT) communication system, or may be a mobile communication device in a group video wireless communication system. Wireless communication device 600 is adapted to receive seed data, from media server 320, the seed data comprising data derived from a header of a last data packet of a first transmitted media stream 312. The first transmitted media stream 312 originates from another mobile communication device, such as first communication device 310 in FIG. 3. Wireless communication device 600 is further adapted to commence transmission of a second transmitted media stream 360. A header of a first packet P1B of the second transmitted media stream 362 comprises the seed data.

As can be seen from FIGS. 2-6, the invention provides a media server 320, which maintains and calculates a state for SSRC, next RTP Sequence Number, and next RTP Timestamp for data packets of media streams of each talkgroup. Media server 320 indicates SSRC, next RTP SequenceNumber, and next RTP Timestamp in floor grant responses. First communication device 310 or second communication device 340 act as a media source, receiving an indicated SSRC, next RTP Sequence Number, and next RTP timestamp in a floor grant. The device then uses these received values to seed SSRC, RTP Sequence Number, and RTP Timestamp for the first packet of a first media stream 312 or the first packet of a second media stream 362, which may be a talkburst. Over the air bit rates may thereby be reduced significantly in a wide variety of PTT usage scenarios, to the benefit of all system participants.

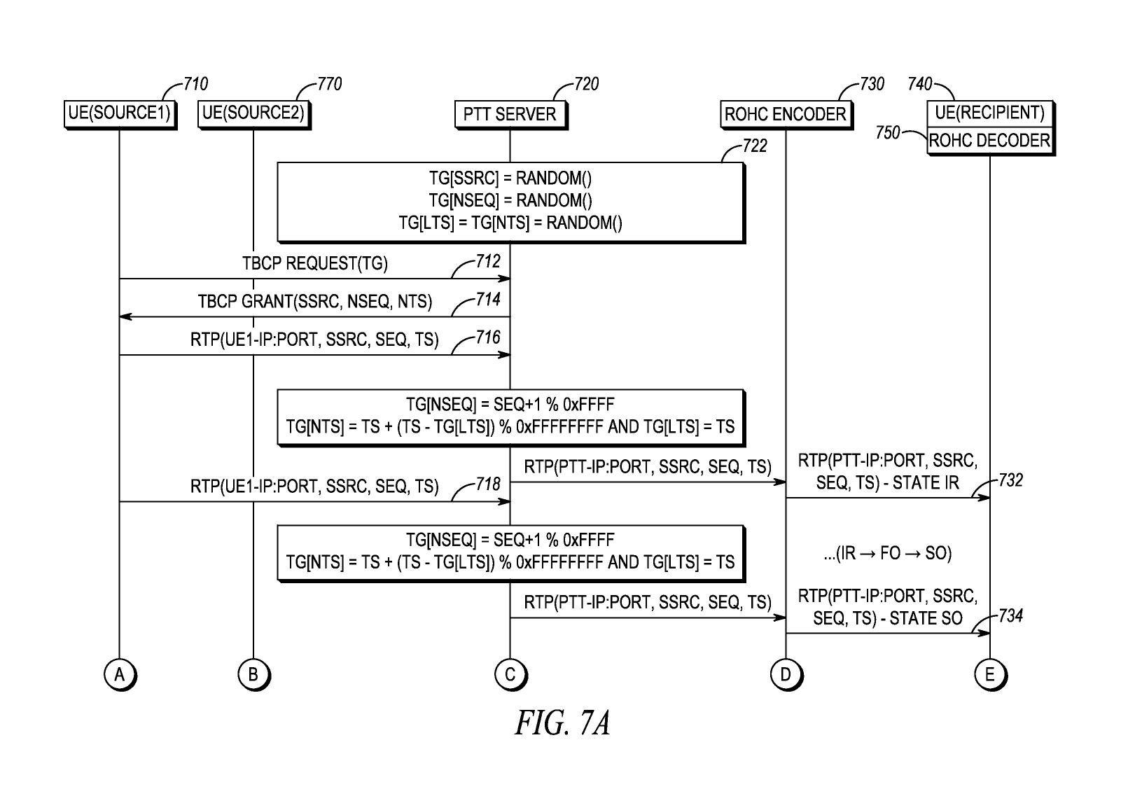

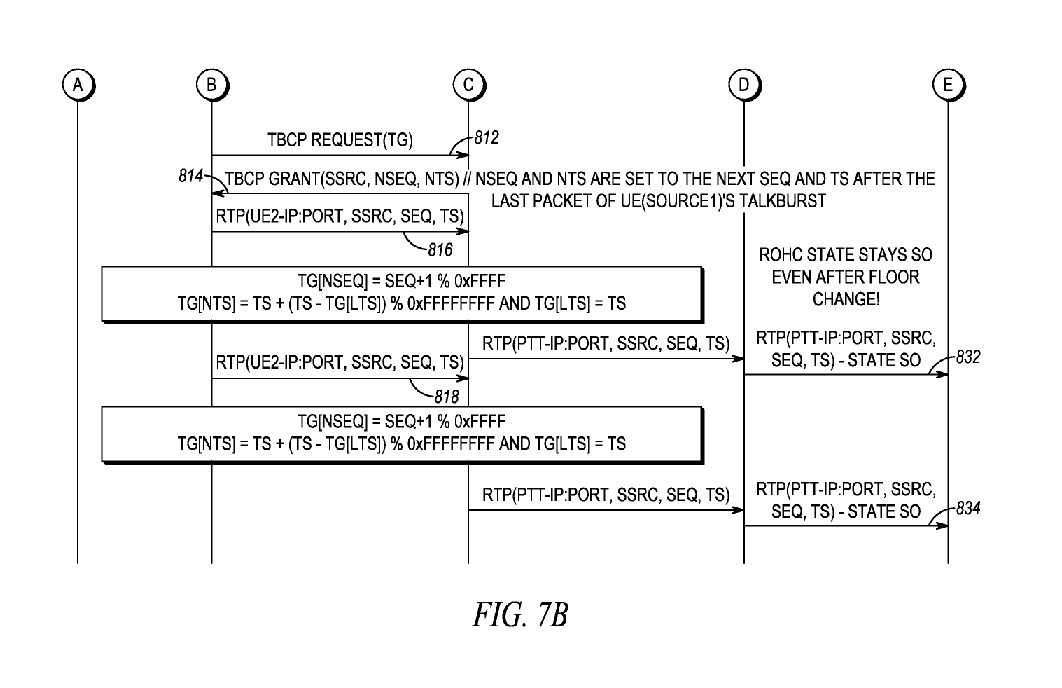

FIG. 7A is a message sequence chart for communications originating from a first communication device. The exemplary media server chosen for the illustration of FIG. 7A is a PTT server. However, a group video media server for a wireless communication system could have been used in the illustrative example of FIG. 7, the group video media server configured whereby mobile communication devices in the system are allowed to send video and speech media streams simultaneously. Similarly, an ROHC encoder is chosen for the illustration of FIG. 7A. However, other types of RTP header compressor could have been used in the illustrative example of FIG. 7.

In FIG. 7A, first communication device 710 is labeled as ‘UE (source 1)’, and corresponds to first communication device 310 of FIG. 3. ‘PTT Server’ 720 of FIG. 7A corresponds to media server 320 of FIG. 2, and receives a first media stream from first communication device 710. The box labeled 722 in FIG. 7A corresponds to table 322 in FIG. 2. ROHC encoder 730 corresponds to ROHC encoder 330 in FIG. 2, and provides header compression for packets received from PTT server 720. A communication device that receives packets from ROHC encoder 730 is shown as ‘UE Recipient’ 740, and comprises ROHC decoder 750.

As illustrated in FIG. 7A, first communication device 710 transmits a TBCP request 712 to PTT server 720. First communication device 710 then receives a TBCP grant 714 from PTT server 720. First communication device 710 then transmits 716, 718 packets of a first media stream. PTT server 720 forwards the packets to ROHC encoder 730. ROHC encoder 730 in turn transmits the packets 732, 734 to UE Recipient 740. UE Recipient 740 in FIG. 7A corresponds to second communication device 340 in FIG. 3, at least as a recipient of media. As shown at 734, the ROHC encoder transitions from the IR to the FO encoding state, and then to the SO state. Hence significant data compression of the packet headers is achieved during the transmission 716, 718 of the first media stream.

FIG. 7B is a message sequence chart for communications originating from a second communication device, after the communications originating from the first communication device in FIG. 7A. Thus the FIGS. 7A and 7B are, respectively, the transmissions up until the timepoint when first communication device 710 has completed a talkburst (FIG. 7A), and subsequent transmissions by a second communication device 770 (FIG. 7B). Second communication device 770 is illustrated in the uppermost row of FIG. 7A, where second communication device 770 is labeled as ‘UE (source 2)’, but only actively transmits in FIG. 7B.

In FIG. 7B, ‘PTT Server’ 720 receives a second media stream from second communication device 770. In this aspect, FIG. 7B differs from the arrangement shown in FIG. 3. In FIG. 3, second communication device 340 functions both as the recipient of the first media stream 312 and as the source of the second media stream 362. In FIG. 7B, the ‘UE Recipient’ 740 is not the same device as the second transmitting communication device 770 that provides the second media stream in FIG. 7B.

As indicated in FIG. 7B, second communication device 770 transmits 812 a TBCP request to PTT server 720. Second communication device 770 then receives 814 a TBCP grant from PTT server 720. In the TBCP grant transmitted at 814, the NSEQ and NTS values are set to the next SEQ and TS values after the final packet of data 734 (FIG. 7A) from the first media stream.

Second communication device 770 then transmits 816, 818 packets of a second media stream. PTT server 720 forwards the packets to ROHC encoder 730. ROHC encoder 730 in turn transmits 832, 834 the packets to UE Recipient 740. As shown at 834, the ROHC encoder remains in the SO encoding state, as it was at the end of the transmission of the first media stream from the first communication device 710. Hence significant data compression of the packet headers is achieved during the transmission 816, 818 of the second media stream. The degree of data compression achieved is greater than with known systems.

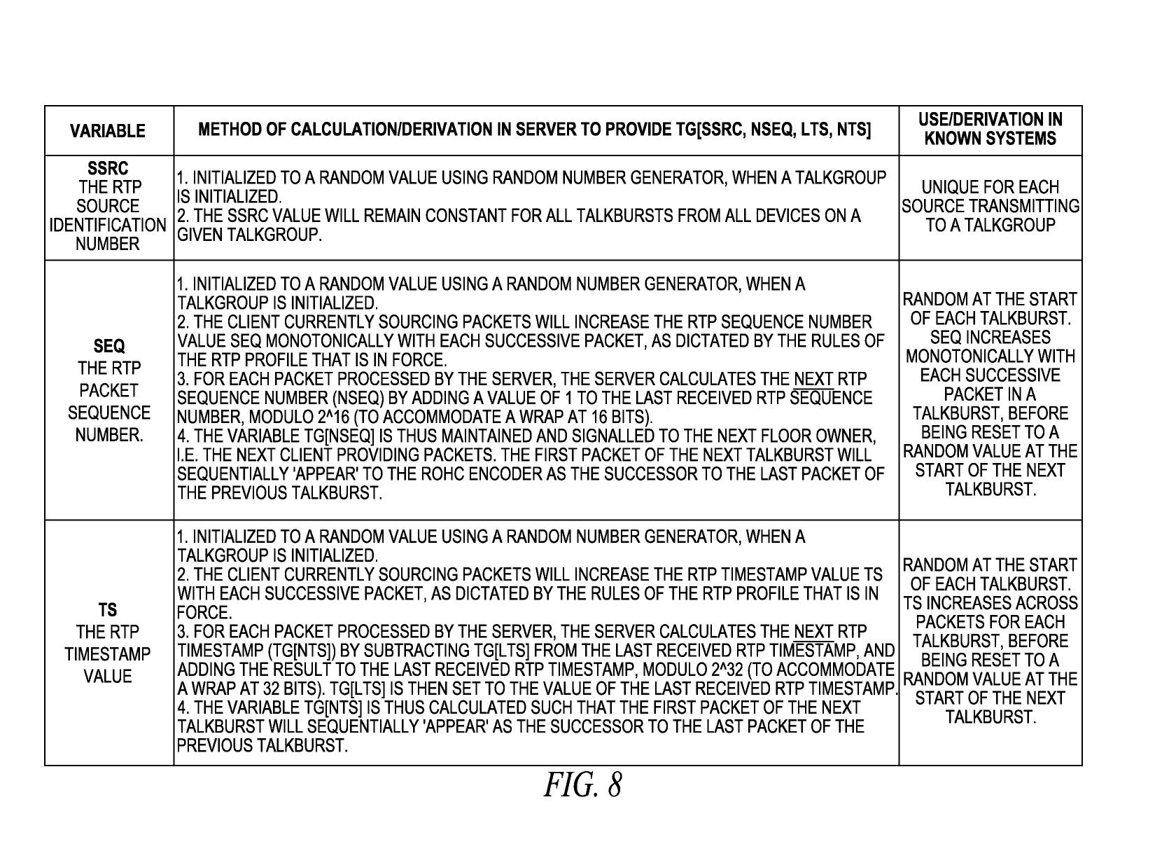

FIG. 8 is a table illustrating the calculation of each variable held in the table 322 of media server 320. For the purposes of comparison, the table of FIG. 8 also illustrates some details of variables used in known systems.

The first column in the table of FIG. 8 identifies the variables in table 322 of media server 320. Each of these variables is part of the 4-tuple TG[SSRC, NSEQ, LTS, NTS]. TG[SSRC, NSEQ, LTS, NTS] and provides up-to-date values of parameters that will be supplied to the next mobile communication device that is to begin transmitting its media stream.

The second column in the table of FIG. 8 explains how media server 320 derives the value of each constituent variable of TG [SSRC, NSEQ, LTS, NTS]. The third column in the table of FIG. 8 explains either how known systems derive the variable in that row, or how the known systems derive the variable that is closest in function to that in the row.

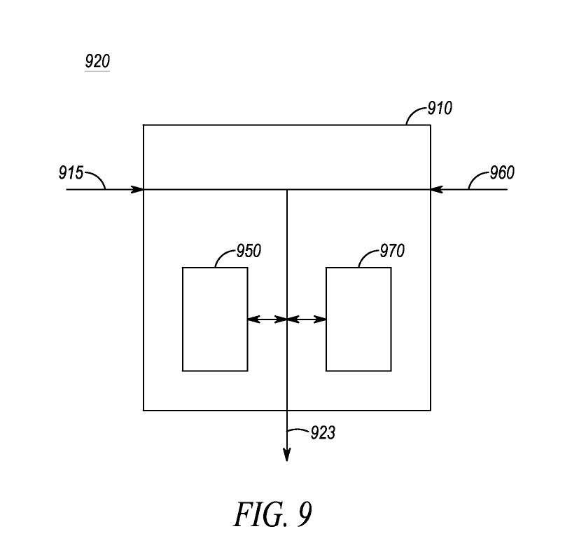

FIG. 9 is a block diagram of a media server 920 in accordance with some embodiments. Media server 920 may correspond to media server 320, described previously in relation to FIG. 3, and PTT server 720, described previously in relation to FIGS. 7A and 7B. Also shown on FIG. 9 are an inbound transmission 915, such as transmission 315 of the first media stream 312 in FIG. 3 from first communication device 310 and another inbound transmission 960, such as transmission 360 of the second media stream 362 of FIG. 3 from second communication device 340. FIG. 9 also depicts an outbound transmission 923 from media server 920, such as the transmission 323 in FIG. 3 of packets to the LTE network 302.

Media server 920 comprises a housing 910. Within housing 910 are at least one memory device 950, which stores program code for implementing the methods described. Memory device 950 is coupled to a processor 970. Memory device 950 may comprise, but is not limited to, a hard disk, a CD-ROM, an optical storage device, a magnetic storage device, random access memory (RAM), dynamic random access memory (DRAM), a ROM (Read Only Memory), a PROM (Programmable Read Only Memory), an EPROM (Erasable Programmable Read Only Memory), an EEPROM (Electrically Erasable Programmable Read Only Memory) a Flash memory, or equivalents. Memory device 950 maintains data and programs that may be executed by the associated processor 970 and that allow media server 920 to perform the functions necessary to operate in communication system 300. Processor 970 may comprise one or more microprocessors, microcontrollers, digital signal processors (DSPs), customized processors, field programmable gate arrays (FPGAs), or combinations thereof or such other devices known to those having ordinary skill in the art. Processor 970 is configured to execute the functions described herein as being executed by media server 920.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A media server in a wireless communication system, the media server operable to receive media streams from mobile communication devices in the wireless communication system and to route the media streams sequentially to a packet header compression encoder, the media server comprising:
a processor configured to:
receive a first media stream from a first mobile communication device;
receive a request from a second mobile communication device to transmit a second media stream to the media server;
transmit data derived from an RTP header of the first media stream to the second mobile communication device;
whereby the second mobile communication device is enabled to commence transmission of the second transmitted media stream using the data derived from the RTP header.

2. The media server of claim 1, wherein:
the communication system is a wireless Push-To-Talk (PTT) communication system.

3. The media server of claim 1, wherein:
the communication system is a group video wireless communication system, configured whereby mobile communication devices in the system are allowed to send audio and/or video media streams simultaneously.

4. The media server of claim 1, wherein:
the first and second media streams comprise packets of digital media;
the RTP header is the header of the last packet of data of the first media stream received by the media server; and
further comprising the processor of the media server being configured to transmit data derived from the RTP header comprising:
a source identifier (SSRC);
a next sequential packet number (NSEQ), derived from a previous sequential packet number of the last packet of data of the first media stream; and
a next time stamp value (NTS), derived from a previous time stamp value of the last packet of data of the first media stream.

5. The media server of claim 4, further comprising:
one or more of the media server and the first mobile communication device being configured to:
when a talkgroup comprising the first mobile communication device is initialized, initialize each of the sequential packet number and the last time stamp value to either a random number or a predetermined number; and
when the media server is responding to a request from the first mobile communication device to transmit the first media stream and the first mobile communication device has initialized both the sequential packet number and the last time stamp value, the processor of the media server is configured to transmit the source identifier to the first communication device.

6. The media server of claim 4, further comprising:
one or more of the media server and the first mobile communication device being configured to:
initialize the source identifier to a random number, when a talkgroup comprising the first communication device was initialized; and
when responding to a request from the first mobile communication device to transmit the first media stream and the media server has initialized the source identifier to a random number, the processor of the media server is configured to transmit the source identifier to the first mobile communication device.

7. The media server of claim 4, further comprising:
one or more of the media server and the first mobile communication device being configured to:
initialize the source identifier to a predetermined number, when a talkgroup comprising the first mobile communication device is initialized; and
when responding to a request from the first mobile communication device to transmit the first media stream and the media server has initialized the source identifier to a predetermined number, the processor of the media server is configured to transmit the source identifier to the first mobile communication device.

8. The media server of claim 1, wherein the RTP header is provided by a RTP Header Compressor and wherein the processor of the media server is configured to:
route the first and second media streams sequentially to the ROHC encoder for onward transmission to mobile communication devices of a talkgroup;
whereby the ROHC encoder will encode a first packet of the second media stream in a compression state that had been used for the last packet of the first media stream.

9. The media server of claim 8, wherein the RTP header compressor is an LTE Robust Header Compression (ROHC) encoder in an LTE communications system, and further comprising the processor of the media server being configured to:
forward the packets of the first and second media streams to the LTE Robust Header Compression (ROHC) encoder,
whereby the ROHC encoder carries out header encoding, prior to repeating the packets over multi-unicast or multicast LTE bearers.

10. The media server of claim 1, further comprising the processor of the media server being configured to:
maintain a table of values for:
a next sequential packet number (NSEQ), derived from a sequential packet number of a current data packet;
a last time stamp value (LTS) of the current data packet;
a next time stamp value (NTS) derived from the LTS;
a source identifier (SSRC).

11. The media server of claim 10, further comprising the processor of the media server being configured to:
responsive to receiving the request from the second mobile communication device to transmit the second media stream to the media server, provide the second mobile communication device with a grant message comprising:
the next sequential packet number (NSEQ);
the next time stamp value (NTS);
the source identifier (SSRC).

12. The media server of claim 11, wherein:
the media server is an OMA PoC server; and
the grant message is a TBCP GRANT message.

13. The media server of claim 10, further comprising the processor of the media server being configured to:
hold a decryption key for a talkgroup, the first mobile communication device and the second mobile communication device forming part of the talkgroup; and
perform integrity validation on received SSRC, RTP Sequence Number, and RTP timestamps of received data packets, before updating the values in the table and a TG [NSEQ, LTS, NTS] state,
wherein the TG [NSEQ, LTS, NTS] state comprises the next sequential packet number (NSEQ), last time stamp value (LTS) and next time stamp value (NTS) in the table.

14. The media server of claim 1, further comprising the processor of the media server being configured to:
repeat the packets of the first and second media streams to affiliated mobile communication devices of the talkgroup over multi-unicast or multicast bearers; and
change a source IP address and a source port to the source IP address and source port of the media server.

15. A media server in a wireless Push-To-Talk (PTT) communication system, the media server operable to receive media streams from mobile communication devices in the wireless Push-To-Talk (PTT) communication system, the media server comprising:
a processor configured to, for a talkgroup comprising multiple mobile communication devices:
maintain a value for a source identifier (SSRC), for an ongoing talkgroup communication;
derive a next sequential packet number (NSEQ) and a next time stamp value (NTS) for a next data packet of the ongoing talkgroup communication; and
transmit the source identifier, the next sequential packet number and the next time stamp value to a mobile communication device requesting the floor for the ongoing talkgroup communication.

16. The media server of claim 15, wherein the RTP header is provided by a Robust Header Compression Encoder (ROHC), and further comprising:
the processor of the media server being configured to route first and second media streams from first and second mobile communication devices, of the multiple mobile communication devices, sequentially to the ROHC encoder for onward transmission to mobile communication devices of a talkgroup,
whereby the ROHC encoder will encode a first packet of the second media stream in a compression state that had been used for the last packet of the first media stream.

17. The media server of claim 16, further comprising:
the processor of the media server being configured to:
initialize one or more of the sequential packet number, the last time stamp value and the source identifier to either a random number or a predetermined number; and
when a talkgroup comprising the first communication device is initialized, transmit one or more of the sequential packet number, the last time stamp value and the source identifier to the first mobile communication device.

18. The media server of claim 15, further comprising the media server being an OMA PoC server, the processor of the media server being configured to:
responsive to receiving a request from a mobile communication device of the multiple mobile communication devices to transmit a media stream to the media server, provide the mobile communication device with a TBCP grant message comprising:
the next sequential packet number (NSEQ);
the next time stamp value (NTS);
the source identifier (SSRC).

19. A mobile communication device in a wireless Push-To-Talk (PTT) communication system, the mobile communication device comprising:
a processor adapted to:
receive seed data, from a media server, the seed data comprising data derived from a header of a last data packet of a first transmitted media stream, the first transmitted media stream originating from another mobile communication device; and
commence transmission of a second transmitted media stream,
whereby a header of a first packet of the second transmitted media stream comprises the seed data.

20. The mobile communication device of claim 19, further comprising the processor of the mobile communication device being operable to include, in the header of the first data packet of the second transmitted media stream:
a next sequential packet number (NSEQ);
a next time stamp value (NTS);
a source identifier (SSRC);
wherein the seed data comprises the next sequential packet number (NSEQ), the next time stamp value (NTS) and the source identifier (SSRC);
wherein the next sequential packet number (NSEQ) is derived from a previous sequential packet number of the last data packet of the first transmitted media stream; and
wherein the next time stamp value (NTS) is derived from a last time stamp value (LTS) of the last data packet of the first transmitted media stream.
